(19) United States
(12) Patent Application Publication
(10) Pub. No.: US 2002/0148363 A1
(43) Pub. Date: Oct. 17, 2002

(54) Spice packaging system

(76) Inventors: John C. Frommer, Las Vegas, NV (US); Renita Outley-Brown, North Las Vegas, NV (US)

Correspondence Address: FRANK J. MCGUE, 10801 N. 32ND STREET SUITE 5, PHOENIX, AZ, 85028

(21) Appl. No.: 09/834,151

(22) Filed: Apr. 12, 2001

(51) Int. Cl. A23L 1/00

(52) U.S. Cl. 99/484

(57) ABSTRACT

A spice packaging system is disclosed which comprises, in combination, a spice container having spices contained therein, a mixing bag, gloves and a brochure, all contained within a single package.

### TECHNICAL FIELD

This invention relates to spices, and, more particularly, to a system for packaging spices for sale.

### BACKGROUND OF THE INVENTION

Outdoor cooking is a popular recreation in the United States. However, once a cook leaves the confines of a home, preparation of meat for the table usually requires transportation of the meat to the picnic site. This is particularly true when hunting.

While some cooks may bring their own spices, such tend to be very simple such as bottled barbeque sauces or salt and pepper and the recipes used are thus very limited. Even when spices are brought, adding the proper amounts to the meat is very much hit and miss since the cook is unlikely to carry a recipe book or recipe file. Thus, there is a need for spice packaging method which brings variety to the outdoor culinary experience and also allows the user a simplified, sanitary procedure while ensuring consistency in the finished product.

Various packaging for spices are well known in the art. Jars, both glass and plastic, and vacuum packages are well known repositories for spices. However, none of the known prior art disclose the system set forth herein.

As used in the present specification, the term “spice” is inclusive and includes seasonings, tenderizers, flavor enhancers and stabilizers.

### SUMMARY OF THE INVENTION

It is an object of this invention to provide an improved spice packaging system for home use or for use in the field.

It is a further object of this invention to provide a spice packaging system which provides recipes to be used easily, sanitarily and quickly at home or in the field.

Further objects and advantages of the invention will become apparent as the following description proceeds and the features of novelty which characterize this invention will be pointed out with particularity in the claims annexed to and forming a part of this specification.

### BRIEF DESCRIPTION OF THE DRAWINGS

The present invention may be more readily described by reference to the accompanying drawings in which:

FIG. 1 is a front view of one embodiment of the present invention;

FIG. 2 is an overview of a kit's contents which incorporates the invention; and

FIG. 3 is front view of a brochure used in the present invention.

### DESCRIPTION OF THE PREFERRED EMBODIMENT

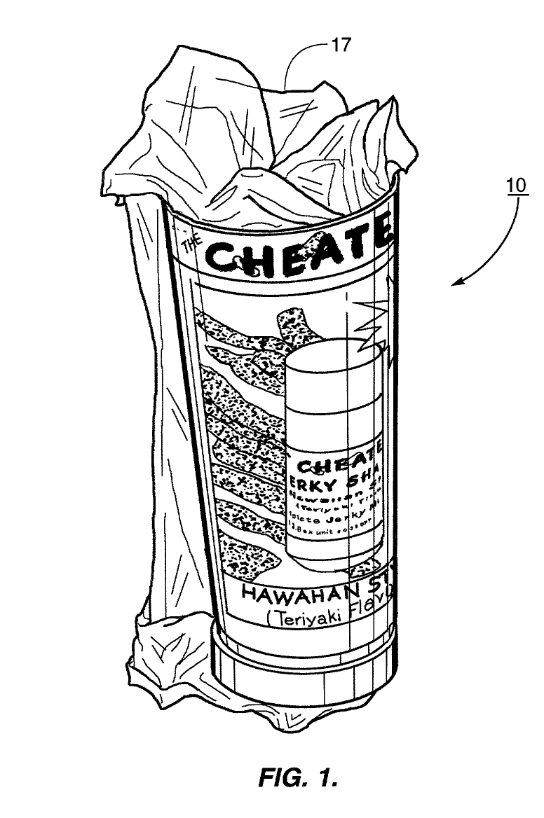

Referring more particularly to the drawings by characters of reference, FIGS. 1-3 disclose one embodiment of a spice packaging system or kit 10 for use in connection with seasoning and cooking game animals (not shown) in the field. Spice packaging system or kit 10 comprises a spice container 12 having spices 16 contained therein, a mixing bag 13, gloves 15 and a brochure 14, all enclosed in packaging 17, in combination.

It should be understood that while the present discussion relates to seasoning and cooking game, the principles of the invention are equally applicable to other uses, for example, picnics, home use and the like.

The present invention is useful for many differing spices and seasonings, for example, seasoning for jerky flavors such as original and a spicy (Cajun) version as well as for sausages such as a breakfast sausage, a Polish sausage, an Italian sausage, a hot link sausage, a bratwurst sausage, or a curing salt, a barbeque seasoning mix, a venison and wild game mix and the like.

One presently preferred embodiment which will be described in detail is for a Hawaiian style (teriyaki flavor) jerky kit. Those skilled in the art will recognize that the previously cited seasoning mixes as well as other mixes are certainly within the scope of the invention.

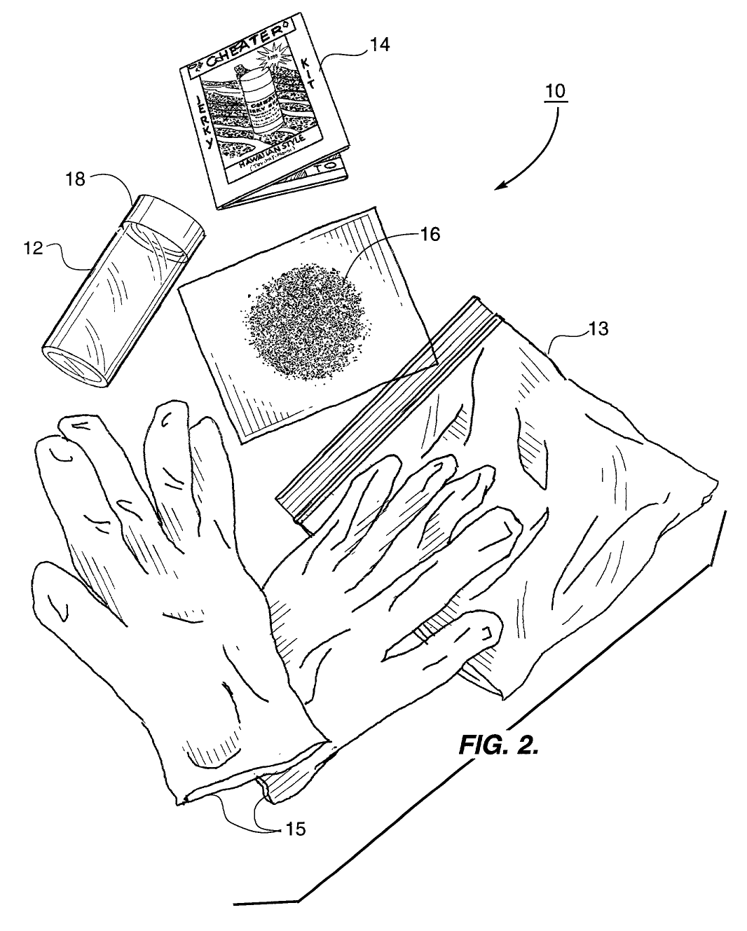

As best seen in FIG. 2, the presently preferred embodiment of container 12 is a shaker bottle 18 having a quantity of spice 16 contained therein and a label 20 having label indicia 22 contained thereon. In addition, while the presently preferred embodiment of spice container 12 is shaker bottle 18, those skilled in the art will recognize that other containers such as vacuum packed bags or jars are suitable for use in the present invention.

In the illustrated embodiment, spice 16 is a Hawaiian style (teriyaki flavor) jerky kit. Label indicia 22 identify said contents and include other information such as, inter alia, a trademark, illustrative photographs, an ingredients listing, a recipe and the weight of spice 16 contained therein as well as product identifying numbers and reordering information.

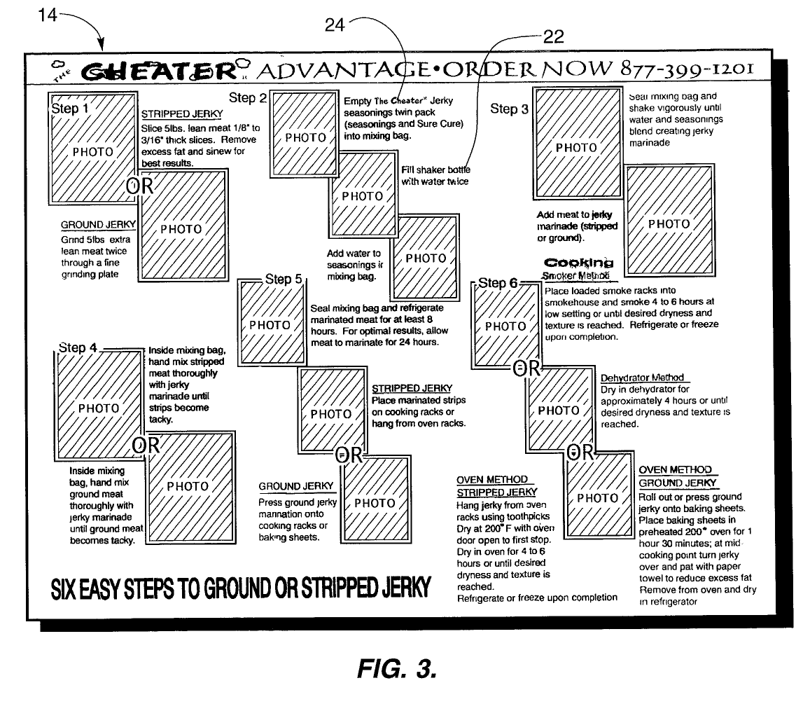

As best seen in FIG. 3, brochure 14 comprises an information packet having brochure indicia 24 thereon. For example, in the illustrated brochure 14, brochure indicia 24 includes a series of photographs to show the user precisely how the product is used. In addition, brochure indicia 24 includes a discussion regarding the background of the spices 16. Such background can include, as in the case of the jerky recipe, directions on preserving the meat during transport as well as providing general tips to preserve meat in addition to use of the stabilizer. As added material, if desired, brochure indicia 24 can include a small catalog of other products available.

The key to system 10 is the recited combination to provide the end user with a host of information as well as the means for applying the information which is otherwise not easily available.

Although only certain embodiments have been illustrated and described, it will be apparent to those skilled in the art that various changes and modifications may be made therein without departing from the spirit of the invention or from the scope of the appended claims.

What is claimed is:

1. A spice packaging system comprises, in combination, a spice container having spices contained therein, a mixing bag, gloves and a brochure, all contained within a single package.

2. The spice packaging system of claim 1 wherein the spice container is a bottle having a quantity of the spice contained therein.

3. The spice packaging system of claim 2 wherein the bottle includes a label having indicia which identify the spice.

4. The spice packaging system of claim 1 wherein the brochure includes indicia having the background history of the spice contained thereon.

5. A spice packaging system comprises, in combination, a bottle having a quantity of spice contained therein, a mixing bag, gloves and a brochure, the brochure including indicia which identify the spice and have the background history of the spice contained thereon, all contained within a single package.
